(19) United States
(12) Patent Application Publication
(10) Pub. No.: US 2023/0413834 A1
(43) Pub. Date: Dec. 28, 2023

(54) Improved Smoking of Bacon

(71) Applicant: GEA FOOD SOLUTIONS BAKEL B.V., Bakel (NL)

(72) Inventor: Ben Kop, Esch (NL)

(21) Appl. No.: 18/037,347

(22) PCT Filed: Nov. 19, 2021
(86) PCT No.: PCT/EP2021/082358

§ 371 Date: May 17, 2023

(30) Foreign Application Priority Data
Nov. 19, 2020 (EP) 20208661.7

(51) Int. Cl. A23B 4/033; A23B 4/048; A23B 4/052; A23L 13/72

(52) U.S. Cl. CPC A23B 4/033; A23B 4/048; A23B 4/0526; A23L 13/72

(57) ABSTRACT

A method to dry and smoke meat that includes process steps of marinating the meat, slicing the meat into individual slices, heating and smoking the slices, and packaging the slices.

### CROSS REFERENCE TO RELATED APPLICATIONS

This application is a US national stage of PCT/EP2021/082358 filed on Nov. 19, 2021 and claims priority to EP 20208661.7 filed Nov. 19, 2020, all of which are hereby incorporated by reference herein for all purposes.

### FIELD

The present invention relates to a method to dry and smoke meat, particularly bacon, that includes sequence process steps of: marination of the meat, slicing of the meat into individual slices, heating and smoking the slices, and packaging the slices; and to a line.

### BACKGROUND

Bacon is nowadays dried and smoked in a batch-ovens prior to slicing and drying. This method has turned out to be very time- and equipment consuming.

### SUMMARY

It is therefore an objective of the present invention to provide a method and a line that overcomes the deficiencies according to the state of the art.

The problem is solved with a method to dry and smoke meat, particularly bacon, comprising the following sequence of process steps:
a. Marination of the meat,
b. Slicing of the meat into individual slices,
c. Heating and smoking of the slices
d. packaging of the slices.

The disclosure made regarding this subject matter of the present invention also applies to the other subject matters of the present application and vice versa. Subject matters disclosed regarding this embodiment of the present invention can also be incorporated into claims directed to a different subject matter and vice versa.

The present invention relates to a method to dry and smoke meat, preferably bacon. The meat, preferably the bacon is provided as a loaf of meat. A loaf is any chunk of meat, particularly belly bacon, back bacon or a reconstituted product, particularly bacon.

In a first step, the meat is marinated with a marination liquid or a solid, for example sugar- and/or salt-powder. Preferably, the marination liquid is injected into the loaf and then the loaf is tumbled in a tumbler.

Subsequently, the meat is sliced into slices with preferably a constant thickness, wherein the thickness is preferably between 0.5 and 10 mm, more preferably 1-5 mm, even more preferably 2-4 mm. The meat slices are then loaded into an oven, preferably on the belt of a continuously operating oven. Preferably, the slices do not or only to a small degree overlap on this belt. In the oven, the slices are, preferably simultaneously heated and smoked. As a last step, the heated and smoked slices are preferably chilled or frozen and then portioned and packaged.

Due to the smoking and/or flavoring of the sliced meat, preferably bacon, exclusively in an oven, the production time is reduced and the meat has an improved flavor and/or an improved appearance. Less equipment, less labor and less process steps are needed. No drying and/or smoking needs to take place prior to slicing.

According to the present invention, the sliced meat, particularly the bacon, is heated. Due to the heating, the meat is dried. Drying according to the present invention means that the weight of the meat is reduced due to a fat- and/or moisture-loss. The drying of the meat can take place due to dripping of a substance, particularly fat and/or water, from the meat and/or due to evaporation of a substance, particularly fat and/or water, from the surface of the meat. Preferably, the weight loss of the product during the heating step is 40-70 weight-% relative to the initial weight of the meat before it enters the oven, more preferably 50-65 weight-%. The drying of the meat is preferably done in a climatized oven with defined temperature and humidity parameters. Preferably, the drying of the food product is carried out at a temperature in the range of 160-190° C. and preferably a dewpoint of 85-100° C. During the drying liquid smoke is preferably atomized in the oven. The residence time of the meat in the oven I preferably 6-16 minutes, more preferably 7-9 min.

According to a preferred embodiment of the present invention, prior to slicing the meat is tempered, preferably frozen, at least partially frozen. The meat is preferably cooled down to a temperature of −5-−9° c.

Preferably, prior to slicing and preferably after tempering, the meat is pressed.

The smoking is preferably carried out by atomizing a smoking- and/or a flavoring-liquid in the oven.

Preferably, the oven comprises means to atomize the smoking- and/or a flavoring-liquid in the oven. The smoking- and/or flavoring-liquid is preferably a water-like-substance. The means to atomize the smoking- and/or flavoring-liquid in the oven is preferably a nozzle, more preferably a two phase nozzle, which is operated with the smoking- and/or flavoring-liquid and a gas, preferably air. The two phase nozzle is preferably supplied with compressed air between 1 and 15 bar, more preferably 3 and 8 bar, even more preferably 4-6 bar. The ratio of the smoking- and/or flavoring-liquid-flow to the nozzle versus the gas-flow to nozzle is preferably 0.1-1.0 kg/m3, more preferably 0.3-0.6 kg/m3. The gas-flow to each nozzle is preferably set to 3.0 to 10.0 m 3 /h, more preferably 5.0 to 6.5 m 3 /h and the smoking- and/or a flavoring-liquid is preferably adjusted at a flow rate of 0.2 to 25 kg/h more preferably 1 to 10 kg/h, even more preferably 3-6 kg/h. The means to atomize the smoking- and/or flavoring-liquid can comprise one or more nozzles, for example an array of nozzles. The atomizing means may provide the atomized smoking- and/or a flavoring-liquid continuously or intermittently. The droplet-size of the atomized smoking- and/or a flavoring-liquid is preferably <3.0 μm, more preferably <1.5 μm and even more preferably <1.0 μm. During the atomization, preferably part of the atomized smoking- and/or flavoring-liquid is ejected from each nozzle as a gas. This part is preferably less than 20 weight %, more preferably 14-16 weight % of the smoking- and/or a flavoring-liquid supplied to the nozzle. The atomized smoking- and/or a flavoring-liquid-stream is preferably ejected into an air-flow which is circulated in one chamber of the oven, whereas the air-flow preferably has a temperature between 50-250° C., more preferably 100-200° C., particularly at the point of ejection of the smoking- and/or flavoring-liquid. The velocity of the air-flow at the point of ejection is preferably between 0.5 and 35 m/s more preferably between 1 and 9 m/s. At least one of the above described conditions assures a complete evaporation of the droplets.

After atomization, the particle size distribution of the droplet is preferably:

| | |
|---|---|
| <0.20 μm | 1.99% |
| <0.50 μm | 6.26% |
| <0.60 μm | 22.48% |
| <0.70 μm | 45.89% |
| <0.85 μm | 69.37% |
| <1.00 μm | 86.70% |
| <5.00 μm | 100.00% |

Preferably, 0.75-5 weight.-%, more preferably 1.5-3 weight.-% of smoking- and/or flavoring-liquid relative to the initial weight of the meat, preferably the bacon, is provided to the oven.

The heating and smoking of the slices is preferably carried out in an oven comprising at least one chamber, preferably two or more chambers. In each chamber a zone with different heat-transfer-, temperature-, humidity- and/or smoking/flavoring-conditions can be established. The product to be treated is meat, preferably bacon. The oven further comprises conveyor means for guiding the sliced meat, preferably the sliced bacon from the inlet through this chamber(s) to the outlet. The conveyor means is preferably at least partially arranged in a helical path. The conveyor means are preferably an endless conveyor belt, which more preferably is at least partially permeable for the process gas, i.e. air, steam and/or the smoke/flavoring-substance. Additionally, the oven comprises temperature control means for adjusting and controlling the temperature and/or the humidity (dew-point) in each chamber using a gas, which is normally a mixture of air and steam. The temperature of the gas is adjusted by a heater. The humidity(dew-point) of the gas is adjusted by adding steam or for example air with a low humidity. Preferably, the gas is circulated in each chamber, preferably separately, preferably by a blower, which extracts the gas out of the chamber at one end and reintroduces the gas at another end. Due to this recirculation, there is a gas-motion in the chamber that improves the heat-transfer from the gas to the meat, preferably bacon and/or reduces temperature differences in each chamber. In the oven, the product is dried and smoked. The drying/smoking preferably takes place at least partially simultaneously and/or at least partially subsequently.

More preferably, the oven comprises two or more chambers, in which a different temperature, different humidity(dew-point) and/or different heat-transfer-conditions can be set, respectively. Preferably each chamber comprises a blower and heating means, whereas the blower and/or the heating means can be operated in each chamber separately. Preferably one or more chambers comprise a helical path and the chambers are more preferably separated from each other, particularly by a third chamber, which is more preferably a section with a straight conveyor belt. Preferably each chamber comprises at least one means to atomize the smoking- and/or a flavoring-liquid, whereas the smoking-and/or flavoring-liquid and/or the operation condition of the means, for example a nozzle, can be different in each chamber, respectively.

Preferably one means is located at the inlet and/or the outlet of the blower of one or each chamber and a smoking- and/or a flavoring-liquid is more preferably continuously fed to this means. More preferably, the smoking- and/or flavoring-liquid is atomized at the suction-side of the blower. In the blower, the droplets and/or the gas-phase of the smoking- and/or flavoring-liquid is mixed with the gas that cooks the product.

The means to spray the smoking- and/or a flavoring-liquid on the product is preferably a nozzle, more preferably a two phase nozzle.

This two phase nozzle for the spray-on-application is preferably fed with compressed gas, more preferably air at 2.0-4.5 bar, more preferably at 3.0 to 3.5 bar. The ratio of the smoking- and/or flavoring-liquid-flow to the nozzle versus the gas-flow to nozzle is preferably 0.5-5.0 kg/m³, more preferably 1.0-2.0 kg/m³. The pressurized gas-, preferably air flow rate to the nozzle is preferably 1.0 to 5.5 m 3 /h, more preferably 3.0 to 3.5 m 3 /h per nozzle and the smoking- and/or flavoring-liquid-flow to the nozzle is more preferably 2.0 to 8.0 kg/h and most preferably 4.0 to 6.0 kg/h. The particle size distribution is preferably between 5 μm and 100 μm, wherein more than 80 weight-% are preferably larger than 5 μm and at least 40% are more preferably larger than 10 μm. Preferably no smoking- and/or flavoring-liquid is directly vaporized by the nozzle.

After atomizing the smoking- and/or flavoring-liquid is preferably superheated, preferably to a temperature >100° C., more preferably to a temperature between 160 and 200° C.

According to a preferred embodiment of the present invention, the oven comprises two separate chambers and preferably a smoking- and/or flavoring liquid is provided to both chambers.

Preferably, the oven is operated 160 and 190° C. and more preferably a dewpoint of 85-100° C.

According to a preferred embodiment of the present invention, fat is blown off the slices.

Additionally, the surface of the product may be treated by impingement of the heating gas on the surface of the product.

Preferably a smoke condensate is utilized for the inventive method comprising:
Phenols: 0.1-0.56%
Carbonyls: 3.5-13.0%
Polysorbate: 0-2.25%
and the rest water.

Another preferred or inventive embodiment of the present invention, is a smoke condensate comprising:
Acids: 2.5-6.5%
Phenols: 0.1-0.56%
Carbonyls: 3.5-13.0%
Polysorbate: 0-2.25%
Benzo(a)pyren<10 ppb
Benzo(a)anthrazen<20 ppb.

Another preferred or inventive embodiment of the present invention, is a smoke condensate comprising:
Phenol 0.1-0.35 weight-%
Carbonyl 3.5-8.5 weight-%
Polysorbate 0-1.5 weight-%

The smoke condensate(s) mentioned above does/do not contaminate the oven and results in a smoking-process that can be well controlled.

The smoke condensate is, for example, produced by condensing smoke resulting from a combustion process. The smoke condensate is preferably filtered and might be concentrated.

Preferably, the ph-value of the smoke condensate is between 2.0 and 3.5.

The viscosity of the smoke condensate is preferably 4.0-5.5 mPas/sec, measured at 20° C.

Another subject matter of the present invention is a line comprising a marination means for marinating a loaf of meat, a slicer for cutting the loaf of meat into slices and an oven for heating and smoking the slices, wherein the oven is provided downstream from the slicer.

The disclosure made regarding this subject matter of the present invention also applies to the other subject matters of the present application and vice versa. Subject matters disclosed regarding this embodiment of the present invention can also be incorporated into claims directed to a different subject matter and vice versa.

This subject matter of the present invention relates to a line. This line comprises a marination apparatus, in which the meat, preferably the bacon, is treated with a marination liquid. Preferably, the marination apparatus comprises an array of needles, which each inject a marination liquid into the meat, preferably the bacon. Additionally or preferably, the meat, preferably the bacon, is preferably tumbled.

After the marination, the meat my be pressed and/or chilled/frozen. The pressing preferably unifies the cross-section of the meat along its length. The length is the dimension of the meat parallel to a transport direction towards a cutting-knife, preferably a rotating cutting knife. The chilling/freezing of the product prior to slicing improves the cutting process. Preferably, the temperature of the meat prior to slicing is −5-−9° C.

In a subsequent step, the meat, preferably the bacon, is sliced into slices with preferably a constant thickness, wherein the thickness is preferably between 0.5 and 10 mm, more preferably 1-5 mm, even more preferably 2-4 mm.

The meat slices are then loaded into an oven, preferably on its conveyor belt of a continuously operating oven. The loading is preferably carried out with a loader, that distributes the slices on the conveyor belt. Preferably, the slices do not or only to a small degree overlap on this belt.

In the oven, the meat is heated and thereby dried. Drying according to the present invention means that the weight of the meat is reduced due to a fat- and/or moisture-loss. The drying of the meat can take place due to dripping of a substance, particularly fat and/or water, from the meat and/or due to evaporation of a substance, particularly fat and/or water, from the surface of the meat. Preferably, the weight loss of the product during the heating step is 40-70 weight-% relative to the initial weight of the meat before it enters the oven, more preferably 50-65 weight-%. The drying of the meat is preferably done in a climatized oven with defined temperature and/or humidity parameters and/or heat transfer condition. Preferably, the drying of the food product is carried out at a temperature in the range of 160-190° C. and preferably a dewpoint of 85-100° C. During the drying liquid smoke is preferably atomized in the oven. The residence time of the meat in the oven is preferably 6-12 minutes, more preferably 7-9 min.

As a last step, the dried and smoked slices are portioned and packaged.

According to the invention, the smoking takes exclusively place after the meat has been sliced. No smoking step and preferably no drying step is needed prior to the slicing.

During and/or after heating liquidized fat, that did not drip from the surface of the meat and/or has not evaporated, can be blown off by an air-jet, preferably directed onto and/or parallel to the slices of meat.

In the oven the smoke condensate is, at least mainly, preferably entirely, transferred into an invisible superheated gas phase.

The inventions are now explained according to FIGS. 1-4. These explanations do not limit the scope of protection. The explanations apply for all inventions of the present application likewise.

### BRIEF DESCRIPTION OF THE DRAWINGS

FIG. 1 shows the inventive line

FIG. 2 shows one embodiment of the oven.

FIG. 3 is a top view of the oven according to FIG. 2.

FIG. 4 shows the adjustment means.

### DETAILED DESCRIPTION

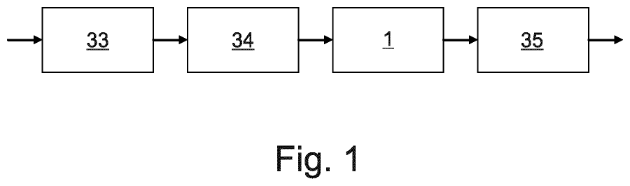

FIG. 1 shows an embodiment of the inventive line. This line comprises a marination apparatus 33, in which the meat, preferably the bacon, is treated with a marination liquid. Preferably, the marination apparatus comprises an array of needles, which each inject a marination liquid into the meat, preferably the bacon. Additionally or preferably, the meat, preferably the bacon, is preferably tumbled.

Between the marination step 33 and the slicing step 34, the meat may be pressed, particularly pressed into a certain from, particularly the cross-section of the meat pressed into a certain form. Bacon is for example may be pressed such that the slices have an essentially rectangular or oval shape.

After margination, and/or prior to slicing 34 and/or prior to pressing, the meat may be chilled, preferably chilled to a temperature of −5-−9° C.

Prior to slicing, no smoking and/or drying must take place.

In a subsequent step 34, the meat, preferably the bacon, is sliced into slices with preferably a constant thickness, wherein the thickness is 0.5 and 10 mm, more preferably 1-5 mm, even more preferably 2-4 mm.

The meat slices are then loaded into an oven (1), preferably on the conveyor belt of a continuously operating oven. Preferably, the slices do not or only to a small degree overlap on this belt. In the oven, the slices are, preferably simultaneously heated and thereby dried and smoked. Drying according to the present invention means that the weight of the meat is reduced due to a fat- and/or moisture-loss. The drying of the meat can take place due to dripping of a substance, particularly fat, from the meat and/or due to evaporation of a substance, particularly fat and/or water, from the surface of the meat. Preferably, the weight loss of the product during the heating step is 40-70 weight-% relative to the initial weight of the meat before it enters the oven, more preferably 50-65 weight-%. The drying of the meat is preferably done in a climatized oven with defined temperature and humidity parameters. Preferably, the drying of the food product is carried out at a temperature in the range of 160-190° C. and preferably a dewpoint of 85-100° C. During the drying liquid smoke is preferably atomized in the oven. The residence time of the meat in the oven I preferably 6-12 minutes, more preferably 7-9 min.

After the oven 1, the line may comprise a freezer, in which the dried and smoked slices are chilled or frozen.

As a last step, the dried and smoked slices are portioned and packaged.

According to the invention, the smoking takes exclusively place in the oven 1 after the meat has been sliced. No smoking step and preferably no drying step is needed prior to the slicing.

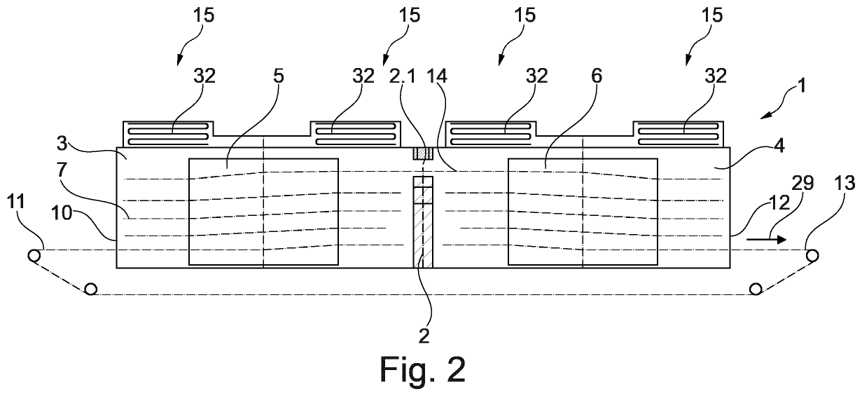

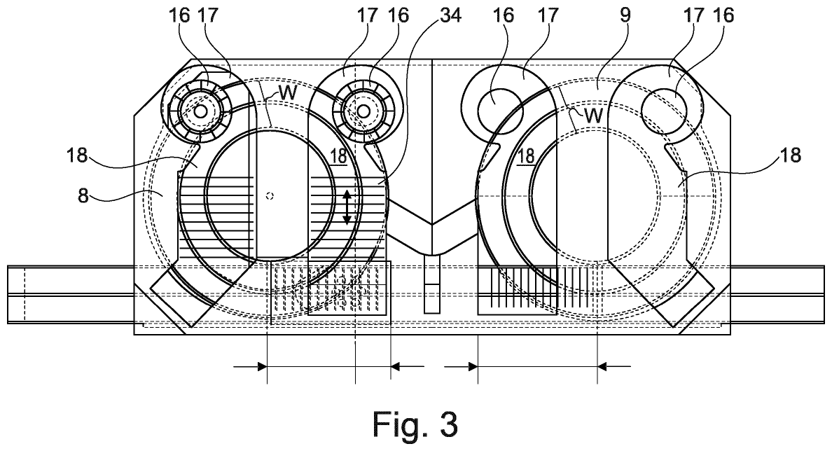

FIGS. 2 and 3 show an example of an oven. The oven 1 comprises a first chamber 3 and a second chamber 4. The chambers are divided by means of a partition 2. In the present case, a rotatable drum 5, 6 is arranged in each of these chambers, around which the conveyor belt 7 is guided along two helical paths 8, 9. The endless conveyor belt enters the oven 1 via the entrance 10 here by a straight conveyor belt section 11 and leaves the oven 1 via the exit 12, here likewise by means of a straight section 13. The two helical sections 8, 9 are here connected by the straight conveyor belt section 14, which lies at the top. The belt is permeable to the process fluid, e.g. air and steam. The partition means 2 comprise a passage 2.1 for the belt section 14. This passage 2.1 is larger than the conveyor belt 14. The person skilled in the art understands that the oven needs not necessarily comprise two chambers, but it is preferred.

The heating means, which are overall denoted by 15, are arranged in the top of the housing. These heating means 15 each comprise a blower 16 here with a spiral casing 17, which opens into a duct 18. A heating element is situated in the ducts 18, respectively. The process fluid, e.g. air and steam, is sucked up by the blower 16 out of chambers 3, 4 via inlet 24 and is forced into the duct 18 via the spiral casing 17, respectively. The process fluid 31 flows past the heating elements 34 and is then recycled into the respective chamber 3, 4. Arrow 23, according to FIG. 3, depicts the fluid flow in the chamber 3, 4. The motion of the products (not depicted) to be cooked in the oven is depicted by arrows 29.

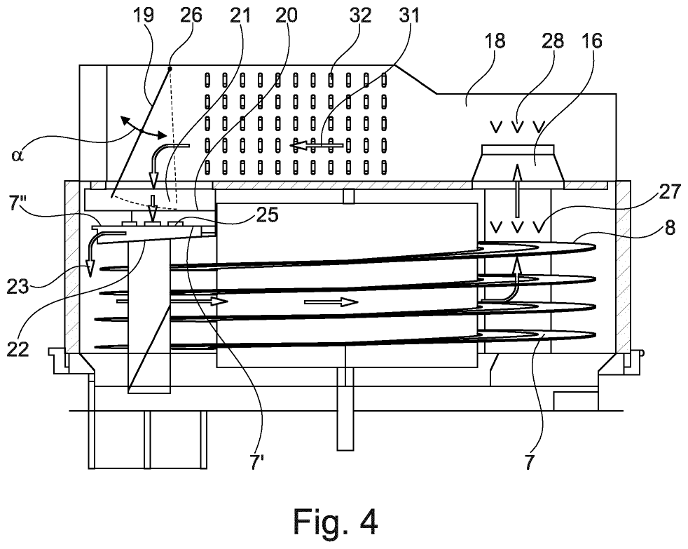

According to FIG. 4 the oven may comprise adjustment means to adjust the flow of process fluid over the width of the belt, which is, in the present example a plate 19. This plate 19 is located in the straight part 14 of the conveyor belt 7 and extends over the length L, as can be seen in FIG. 2. The plate 19 is partially located in the duct 18 and extends into a control area 21. The plate 19 pivots around an axis 26. The degree of deflection relative to its vertical position is depicted by double-arrow α. The plate 19 guides and splits the fluid flow 31 after it has passed the heating means, so that the desired flow pattern over the width of the conveyor belt is achieved. By means of the plate 19, the flow 31 can be split and guided from the outside 7″ of belt 7 to the inside 7′ and vice versa. Every desired fluid-flow distribution over the width W can be achieved by means of plate 19. Examples for fluid-flow distributions are shown in FIG. 7. The desired fluid-flow distribution is achieved over the entire length L of plate 19. Equalization means 20, here a perforated plate, are located at the bottom of the control area 21 to support the flow-distribution of plate 19 and/or increase the pressure in the control area. After the fluid flow has heated products 25, it passes through the permeable belt 7 and is the deflected by an inclined plate 22. The flow 23 inside chamber 3 flows past the helical path 8 and is then sucked up again by blower 16 via inlet 24. The person skilled in the art understands that these adjustment means are not mandatory for the present invention.

Upstream and/or downstream from the blower 16 and/or upstream and/or downstream from the heater 32, means 27, 28 to atomize a smoking- and/or a flavoring-liquid, in the present case one or more two-phase nozzles 27, 28, are provided. The atomized smoking- and/or a flavoring-liquid is provided as a cloud of very fine fluid particles and ejected into the air-stream 31, in which the droplets evaporate before they coalesce. Each two phase nozzle 27, 28 is operated with a pressurized gas (not shown) in order to divide the stream of smoking-and/or a flavoring-liquid into the fine particles and to distribute the droplets in the air-stream 31. The smoking- and/or a flavoring-liquid can be provided to each or only one chamber 3, 4. The smoking- and/or a flavoring-liquid can also be introduced at different locations into the oven.

Each chamber is preferably supplied with the same smoking- and/or a flavoring-liquid. Each chamber is preferably supplied with the same amount of smoking- and/or a flavoring-liquid per time unit. After the smoking- and/or a flavoring-liquid has been supplied to the chambers, the smoking- and/or a flavoring-liquid is super-heated to a temperature >100° C., preferably 160-200° C. Particularly, the temperature in the two chambers is preferably different, wherein the temperature of the downstream chamber is preferably higher than the temperature in the upstream chamber, preferably by a difference of 10-40° C., more preferably 15-35° C. The dew-point in the two chambers is preferably different, wherein the dew-point of the downstream chamber is preferably lower than the dew-point in the upstream chamber, preferably 1-10° C., more preferably 4-8° C. The residence time of the meat slices in the oven is preferably 6-16 minutes, more preferably 7-9 min. The conditions mentioned in this paragraph particularly apply to the drying and smoking of bacon slices.

### REFERENCE SIGNS

1 oven
2 separation means, partition
2.1 passage from first- to second chamber
3 first chamber
4 second chamber
5 drum
6 drum
7 conveyor means, conveyor belt
8 helical section first chamber
9 helical section second chamber
10 inlet
11 straight conveyor means
12 outlet
13 straight conveyor means
14 connecting conveyor means section
15 heating means
16 blower
17 spiral casing
18 air duct
19 control means, valve
20 equalization means
21 control area, box
22 guiding means
23 flow of the fluid
24 inlet
25 product
26 pivot
27 nozzle
28 nozzle
29 motion of the product
30 line
31 process fluid, air, steam and/or smoke
32 heating means
33 marination means
34 slicer
35 packaging

1. A method to dry and smoke meat, comprising the following sequence of process steps:
a. marinating the meat,
b. slicing of the meat into individual slices,
c. heating and smoking the slices, and
d. packaging the slices.

2. The method according to claim 1, wherein the marinating step is carried out by injecting a marination liquid into the meat and/or tumbling.

3. The method according to claim 1, wherein prior to the slicing step, the meat is tempered or frozen.

4. The method according to claim 3, wherein prior to the slicing step and after the tempering step, the meat is pressed.

5. The method according to claim 1, wherein the smoking step is carried out by atomizing a smoking- and/or a flavoring-liquid in an oven.

6. The method according to claim 1, wherein fat is blown off the slices.

7. The method according to claim 1, wherein at least part of the method takes place in an over, the oven comprises two separate chambers and a smoking and/or flavoring liquid is provided to both of the chambers.

8. The method according to claim 7, wherein the oven is operated between 160° C. and 190° C. and at a dewpoint between 85° C. and −100° C.

9. The method according to claim 7, wherein no fresh air is supplied to the oven.

10. A line comprising a marination means for marinating a loaf of meat, a slicer for cutting the loaf of meat into slices, and an oven for drying and smoking the slices, wherein the oven is provided downstream from the slicer.

11. The line according to claim 10, wherein the oven comprises:
at least one chamber;
conveyor means for guiding products from the inlet through the at least one chamber to an outlet;
temperature control means for adjusting and controlling temperature and/or humidity in the at least one chamber using a gas which comprises a heater to heat the gas, a blower, and a duct to introduce the heated gas into the at least one chamber; and
means to atomize a smoking- and/or a flavoring-liquid in the oven.

12. The line according to claim 11, wherein the means is a nozzle, or a two phase nozzle.

13. The line according to claim 11, wherein the oven comprises fat blow-off means.
